(19) United States
(12) Patent Application Publication
(10) Pub. No.: US 2012/0257987 A1
(43) Pub. Date: Oct. 11, 2012

(54) COVER STRUCTURE FOR CRYOPUMP, CRYOPUMP, START-UP METHOD OF CRYOPUMP, AND STORAGE METHOD OF CRYOPUMP

(75) Inventor: Hidekazu Tanaka, Tokyo (JP)

(73) Assignee: SUMITOMO HEAVY INDUSTRIES, LTD., Tokyo (JP)

(21) Appl. No.: 13/437,447

(22) Filed: Apr. 2, 2012

(30) Foreign Application Priority Data
Apr. 5, 2011 (JP) 2011-083629

(51) Int. Cl. F04B 37/08; B01D 8/00; F04B 53/00

(52) U.S. Cl. 417/53; 417/313; 62/55.5; 417/901

(57) ABSTRACT

A storage method of a cryopump is provided, the storage method including: closing, with a pump cover, a pump inlet in the cryopump for receiving gases to be pumped by the cryopump; and reducing a pressure in the cryopump through a fluid channel for communicating an interior of the cryopump to an exterior of the cryopump. A start-up method of a cryopump is also provided, the start-up method including releasing a negative pressure in the cryopump by removing a closing member from a cover main body of a pump cover mounted to the cryopump.

### BACKGROUND OF THE INVENTION

1. Field of the Invention

The present invention relates to a cover structure for a cryopump, a cryopump, a start-up method of a cryopump, and a storage method of a cryopump.

2. Description of the Related Art

A cryopump is a vacuum pump that captures and pumps gas molecules by condensing or adsorbing molecules on a cryopanel cooled to an extremely low temperature. A cryopump is generally used to achieve a clean vacuum environment required in a semiconductor circuit manufacturing process. Charcoal is adhered to the cryopanel for adsorbing gases.

### SUMMARY OF THE INVENTION

An embodiment of the present invention relates to a cover structure for maintaining an inside of a cryopump at a negative pressure. The cover structure includes a cover main body configured to close a pump inlet in the cryopump. The cover main body has a small hole for communicating the inside of the cryopump to an outside of the cryopump. The cover structure includes a closing member configured to close the small hole.

Another embodiment of the present invention relates to a start-up method of a cryopump. The method includes releasing a negative pressure in the cryopump by removing a closing member in the structure of a cover mounted to the cryopump.

Still another embodiment of the present invention relates to a storage method of a cryopump. The method comprises: closing, with a cover, a pump inlet in the cryopump for receiving gases to be pumped by the cryopump; and reducing a pressure in the cryopump through a fluid channel for communicating an interior of the cryopump to an exterior of the cryopump.

### BRIEF DESCRIPTION OF THE DRAWINGS

Embodiments will now be described, byway of example only, with reference to the accompanying drawings, which are meant to be exemplary, not limiting, and wherein like elements are numbered alike in several figure, in which:

FIG. 1 is a view schematically illustrating a cryopump according to an embodiment of the present invention;

FIG. 2 is a view schematically illustrating a pump cover for a cryopump according to an embodiment of the invention;

FIG. 3 is a flowchart for explaining a storage method of a cryopump according to an embodiment of the invention; and

FIG. 4 is a flowchart for explaining a start-up method of a cryopump according to an embodiment of the invention.

### DETAILED DESCRIPTION OF THE INVENTION

The invention will now be described by reference to the preferred embodiments. This does not intend to limit the scope of the present invention, but to exemplify the invention.

Even while a cryopump is not being used, for example, while being stored or transported, an adsorbent on a cryopanel can adsorb surrounding components. For example, when open air can enter the inside of a cryopump during a period between the shipment and the beginning of use of the cryopump, the absorbent can adsorb a lot of moisture. Prior to the use of a cryopump, the inside of the cryopump is vacuumed to the operating pressure of the cryopump by using another auxiliary vacuum pump. Because the adsorbed components are released from charcoal at the time, it takes a long time to reach the operating pressure.

One of the exemplary purposes of an embodiment of the present invention is to store a cryopump in a good condition before the beginning of use of the cryopump.

A cover structure according to an embodiment of the present invention is used for maintaining the inside of a cryopump at a negative pressure and comprises: a cover main body configured to close a pump inlet in the cryopump, the cover main body having a small hole for communicating the inside of the cryopump to the outside; and a closing member configured to close the small hole.

According to this embodiment, the vacuum inside a cryopump can be broken by an easy operation of removing the closing member before the beginning of use of the cryopump, and hence it actually becomes easy to store the cryopump in a state in which the inside thereof is maintained at a vacuum or negative pressure. By reducing a pressure in the cryopump, it becomes possible to maintain the cryopump, in particular, the built-in adsorbent in a condition as good as in the initial stage of storage.

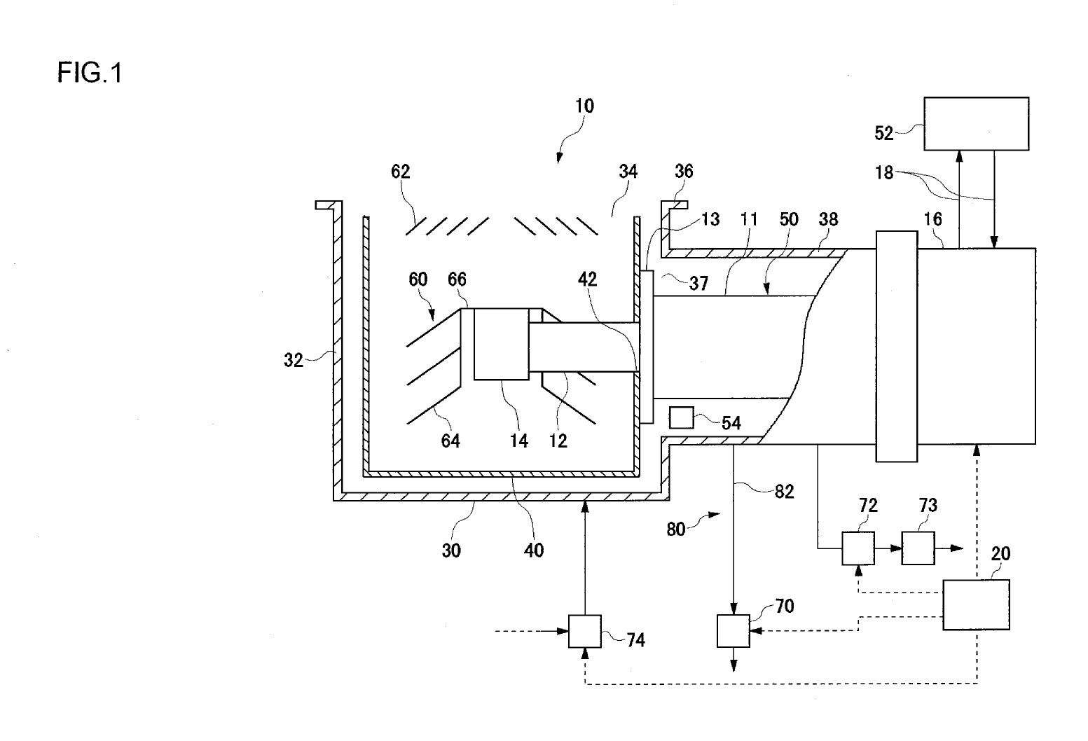

FIG. 1 is a view schematically illustrating a cryopump 10 according to an embodiment of the present invention. The cryopump 10 is mounted onto a vacuum chamber of an apparatus, such as an ion implantation apparatus, a sputtering apparatus, or the like, to be used to enhance the degree of vacuum in the inside of the vacuum chamber to a level required in a desired process. The cryopump 10 is configured to include a cryopump housing 30, a radiation shield 40, and a refrigerator 50.

The refrigerator 50 is, for example, a Gifford-McMahon refrigerator (so-called GM refrigerator) or the like. The refrigerator 50 is provided with a first cylinder 11, a second cylinder 12, a first cooling stage 13, a second cooling stage 14, and a valve drive motor 16. The first cylinder 11 and the second cylinder 12 are connected in series. The first cooling stage 13 is installed on one end of the first cylinder 11 where the first cylinder 11 is connected with the second cylinder 12. The second cooling stage 14 is installed on the second cylinder 12 at the end that is farthest from the first cylinder 11. The refrigerator 50 illustrated in FIG. 1 is a two-stage refrigerator in which a lower temperature is attained by combining two cylinders in series. The refrigerator 50 is connected to a compressor 52 through a refrigerant pipe 18.

The compressor 52 compresses a refrigerant gas, i.e., an operating gas, such as helium or the like, and supplies the gas to the refrigerator 50 through the refrigerant pipe 18. While cooling the operating gas by allowing the gas to pass through a regenerator, the refrigerator 50 further cools the gas by expanding the gas in an expansion chamber inside the first cylinder 11 and in an expansion chamber in the second cylinder 12. The regenerator is installed inside the expansion chambers. Thereby, the first cooling stage 13 installed in the first cylinder 11 is cooled to a first cooling temperature level while the second cooling stage 14 installed in the second cylinder 12 is cooled to a second cooling temperature level lower than the first cooling temperature level. For example, the first cooling stage 13 is cooled to approximately 65-100 K while the second cooling stage 14 is approximately 10-20 K.

The operating gas, which has absorbed heat by expanding in the respective expansion chambers and cooled the respective cooling stages, passes through the regenerator again and is returned to the compressor 52 through the refrigerant pipe 18. The flows of the operating gas from the compressor 52 to the refrigerator 50 and from the refrigerator 50 to the compressor 52 are switched by a rotary valve (not illustrated) in the refrigerator 50. A valve drive motor 16 rotates the rotary valve by receiving power from an external power source.

A control unit 20 for controlling the refrigerator 50 is provided. The control unit 20 controls the refrigerator 50 based on the cooling temperature of the first cooling stage 13 or the second cooling stage 14. For this purpose, a temperature sensor (not illustrated) may be provided on the first cooling stage 13 or the second cooling stage 14. The control unit 20 may control the cooling temperature by controlling the driving frequency of the valve drive motor 16. For this purpose, the control unit 20 may be provided with an inverter for controlling the valve drive motor 16. The control unit 20 may be configured so as to control the compressor 52, and respective valves that will be described later. The control unit 20 may be provided to be integrated with the cryopump 10 or be configured as a control device separate from the cryopump 10.

The cryopump 10 illustrated in FIG. 1 is a so-called horizontal-type cryopump. In the horizontal-type cryopump, the second cooling stage 14 of the refrigerator is generally inserted into the radiation shield 40 along the direction that intersects (usually orthogonally) with the axial direction of the cylindrical radiation shield 40. The present invention is also applicable to a so-called vertical-type cryopump in a similar way. In the vertical-type cryopump, the refrigerator is inserted along the axial direction of the radiation shield.

The cryopump housing 30 has a portion 32 formed into a cylindrical shape (hereinafter, referred to as a “trunk portion”) 32, one end of which is provided with an opening and the other end is closed. The opening is provided as a pump inlet 34 for receiving gases to be pumped from the vacuum chamber in a sputtering apparatus, etc., in which the cryopump is to be mounted. The pump inlet 34 is defined by the inner surface of the upper end of the trunk portion 32 of the cryopump housing 30. In addition to an opening as the pump inlet 34, an opening 37 for inserting the refrigerator 50 is also formed in the trunk portion 32. One end of a cylindrically-shaped refrigerator container 38 is fitted to the opening 37 in the trunk portion 32, while the other end thereof is fitted to the housing of the refrigerator 50. The refrigerator container 38 contains the first cylinder 11 of the refrigerator 50.

At the upper end of the trunk portion 32 of the cryopump housing 30, a mounting flange 36 extends outwardly in the radial direction. The cryopump 10 is mounted, by using the mounting flange 36, to a vacuum chamber in which the cryopump 10 is to be mounted.

The cryopump housing 30 is provided in order to separate the inside of the cryopump 10 from the outside thereof. As described above, the cryopump housing 30 is configured to include the trunk portion 32 and the refrigerator container 38, and the trunk portion 32 and the refrigerator container 38 are maintained to be gastight such that the respective insides thereof have a common pressure. Thereby, the cryopump housing 30 functions as a vacuum vessel during the pumping operation of the cryopump 10. Because the outer surface of the cryopump housing 30 is exposed to the environment outside the cryopump 10 during the operation of the cryopump 10, i.e., even during the operation of the refrigerator, the outer surface is maintained at a temperature higher than that of the radiation shield 40. The temperature of the cryopump housing 30 is typically maintained at an ambient temperature. Herein, the ambient temperature refers to a temperature of a place where the cryopump 10 is installed or a temperature close to the temperature. The ambient temperature may be, for example, at or around room temperature.

A pressure sensor 54 is provided in the refrigerator container 38 of the cryopump housing 30. The pressure sensor 54 periodically measures the internal pressure of the refrigerator container 38, i.e., the pressure in the cryopump housing 30 and outputs a signal indicating the measured pressure to the control unit 20. The pressure sensor 54 is connected to the control unit such that the output thereof can be communicated. Alternatively, the pressure sensor 54 may be provided in the trunk portion 32 of the cryopump housing 30.

The pressure sensor 54 has a wide measurement range including both a high vacuum level attained by the cryopump 10 and the atmospheric pressure level. It is desirable that at least a pressure range, which can be generated during a regeneration process, is included in the measurement range. In the present embodiment, it is preferable to use, for example, a crystal gauge as the pressure sensor 54. The crystal gauge refers to a sensor that measures a pressure by using a phenomenon in which the oscillation resistance of a crystal oscillator varies with a pressure. Alternatively, the pressure sensor 54 may be a Pirani gauge. A pressure sensor for measuring a vacuum level and another pressure sensor for measuring an atmospheric pressure level may be individually provided in the cryopump 10.

A vent valve 70, a rough valve 72 and a purge valve 74 are connected to the cryopump housing 30. The opening/closing of each of the vent valve 70, rough valve 72, and purge valve 74 are controlled by the control unit 20.

The vent valve 70 is provided, for example, at the end of an exhaust line 80. Alternatively, the vent valve 70 may be provided in the middle of the exhaust line 80 and a tank or the like for collecting discharged fluid may be provided at the end of the exhaust line 80. By the opening of the vent valve 70, the flow of fluid in the exhaust line 80 is permitted, and by the closing of the vent valve 70, the flow of the fluid in the exhaust line 80 is blocked. Although the fluid to be discharged is basically a gas, the fluid may be a liquid or a mixture of gas-liquid. For example, liquefied gas that has been condensed by the cryopump 10 may be mixed with the fluid to be discharged. By the closing of the vent valve 70, the positive pressure generated in the cryopump housing 30 can be released to the outside.

The exhaust line 80 is an additional fluid channel, different from the pump inlet 34, for communicating the inside of the cryopump 10 to the outside. Accordingly, by providing an appropriate vacuum pump in the exhaust line 80 or by connecting the exhaust line 80 to an appropriate vacuum pump, it becomes possible to reduce the pressure in the cryopump 10 through the exhaust line 80.

The exhaust line 80 includes an exhaust duct 82 for exhausting fluid from the internal space of the cryopump 10 to an external environment. The exhaust duct 82 is connected to, for example, the refrigerator container 38 in the cryopump housing 30. Although the exhaust duct 82 is a duct having a circular cross section orthogonal to the direction of the flow, the exhaust duct 82 may have a cross section of any other shapes. The exhaust line 80 may include a filter for removing foreign bodies from the fluid to be discharged through the exhaust duct 82. The filter may be provided upstream from the vent valve 70 in the exhaust line 80.

The vent valve 70 is configured to function as a so-called safety valve. The vent valve 70 is, for example, a normally-closed control valve that is provided in the exhaust duct 82. Further, the valve-closing force of the vent valve 70 is set in advance such that the vent valve 70 can be mechanically opened when being subject to a predetermined differential pressure. The preset differential pressure can be appropriately set by taking into consideration, for example, the internal pressure that can be exerted upon the cryopump housing 30 and the structural durability of the cryopump housing 30, etc. Because the external environment of the cryopump 10 is normally at the atmospheric pressure, the preset differential pressure is set to a predetermined pressure relative to the atmospheric pressure.

The vent valve 70 is opened by the control unit 20 when fluid is discharged from the cryopump 10, for example, during a regeneration process. When fluid should not be discharged, the vent valve 70 is closed by the control unit 20. On the other hand, the vent valve 70 is mechanically opened when the preset differential pressure is exerted thereon. As a result, when the internal pressure of the cryopump rises too high for some reasons, the vent valve 70 is opened mechanically without requiring control. Thereby, the internal high pressure can be released. Thus, the vent valve 70 functions as a safety valve. By making the vent valve 70 also have the function of a safety valve in this way, advantages of cost reduction and space saving can be achieved in comparison with the case where two valves are separately provided.

The rough valve 72 is connected to a roughing pump 73. The rough valve 72 is also provided in a further fluid channel different from the pump inlet 34 for communicating the inside of the cryopump 10 to the outside. The roughing pump 73 and the cryopump 10 are communicated with or blocked from each other by the opening/closing of the rough valve 72. The roughing pump 73 is typically provided as a vacuum apparatus different from the cryopump 10, and forms, for example, part of a vacuum system including the vacuum chamber to which the cryopump 10 is connected. The pressure in the cryopump 10 can be reduced by opening the rough valve 72 and by operating the roughing pump 73.

The purge valve 74 is connected to a non-illustrated purge gas supply apparatus. A purge gas is, for example, a nitrogen gas. The control unit 20 controls the purge valve 74, thereby allowing the supply of the purge gas to the cryopump 10 to be controlled.

The radiation shield 40 is arranged inside the cryopump housing 30. The radiation shield 40 is formed into a cylindrical shape, one end of which is provided with an opening and the other end is closed, that is, a cup-like shape. The radiation shield 40 may be formed into an integrated tubular shape as illustrated in FIG. 1, or may be formed with a plurality of parts to have a tubular shape as a whole. The plurality of parts may be arranged so as to have a gap between one and another.

The trunk portion 32 of the cryopump housing 30 and the radiation shield 40 are both formed into approximately cylindrical shapes and are arranged concentrically. The inner diameter of the trunk portion 32 of the cryopump housing 30 is slightly larger than the outer diameter of the radiation shield 40. Therefore, the radiation shield 40 is arranged in a non-contact state with the cryopump housing 30, i.e., in a state of having a slight gap with the inner surface of the trunk portion 32 of the cryopump housing 30. That is, the outer surface of the radiation shield 40 faces the inner surface of the cryopump housing 30. The shapes of the trunk portion 32 of the cryopump housing 30 and the radiation shield 40 are not limited to a cylindrical shape, but may be a tubular shape having any cross section, such as a rectangular tube shape or elliptical tube shape. Typically, the shape of the radiation shield 40 is made to be analogous to the shape of the inner surface of the trunk portion 32 of the cryopump housing 30.

The radiation shield 40 is provided as a radiation shield to protect both the second cooling stage 14 and a low-temperature cryopanel 60, which is thermally connected to the second cooling stage 14, from the radiation heat mainly from the cryopump housing 30. The second cooling stage 14 is arranged substantially on the central axis of the radiation shield 40 in the radiation shield 40. The radiation shield 40 is fixed to the first cooling stage 13 in a thermally connected state, so that the radiation shield 40 is cooled to a temperature almost the same as that of the first cooling stage 13.

The low-temperature cryopanel 60 includes, for example, a plurality of panels 64. Each of the panels 64 has, for example, the shape of the side surface of a truncated cone, i.e., a so-called umbrella-like shape. Each panel 64 is attached to a panel mounting member 66 that is fixed to the second cooling stage 14. An adsorbent (not illustrated), such as charcoal, is typically provided on each panel 64. The adsorbent is adhered to, for example, the back surface of the panel 64. The plurality of panels 64 are attached to the panel mounting member 66 so as to have a space between one and another. The plurality of panels 64 are arrayed in a direction toward the inside of the pump, when viewed from the pump inlet 34.

A baffle 62 is provided in the inlet of the radiation shield 40 in order to protect both the second cooling stage 14 and the low-temperature cryopanel 60, which is thermally connected to the stage, from the radiation heat emitted from the vacuum chamber, etc. The baffle 62 is formed into, for example, a louver structure or a chevron structure. The baffle 62 may be formed into a concentric circle shape whose center is the central axis of the radiation shield 40, or may be formed into another shape such as a lattice-like shape. The baffle 62 is mounted at the opening end of the radiation shield 40 and cooled to a temperature almost the same as that of the radiation shield 40.

A refrigerator mounting hole 42 is formed on the side surface of the radiation shield 40. The refrigerator mounting hole 42 is formed at the center of the side surface of the radiation shield 40 with respect to the central axis of the radiation shield 40. The refrigerator mounting hole 42 of the radiation shield 40 is provided coaxially with the opening 37 of the cryopump housing 30. The second cylinder 12 and the second cooling stage 14 of the refrigerator 50 are inserted through the refrigerator mounting hole 42 along the direction perpendicular to the central axis of the radiation shield 40. The radiation shield 40 is fixed to the first cooling stage 13 at the refrigerator mounting hole 42 so as to be thermally connected to the stage 13.

As an alternative to the direct mounting of the radiation shield 40 to the first cooling stage 13, the radiation shield 40 may be mounted in the first cooling stage 13 by a connecting sleeve. The sleeve is, for example, a heat transfer member for surrounding one end of the second cylinder 12 near to the first cooling stage 13 and for thermally connecting the radiation shield 40 to the first cooling stage 13.

Operations of the cryopump 10 with the aforementioned configuration will be described below. In operating the cryopump 10, the inside of the cryopump housing 30 is first roughly evacuated to approximately 1 Pa by the roughing pump 73 through the rough valve 72 before starting the operation. The pressure is measured by the pressure sensor 54. Thereafter, the cryopump 10 is operated. By driving the refrigerator 50, the first cooling stage 13 and the second cooling stage 14 are cooled under the control of the control unit 20, thereby the radiation shield 40, the baffle 62, and the cryopanel 60, which are thermally connected to the stages, are also cooled.

The cooled baffle 62 cools the gas molecules flowing from the vacuum chamber into the cryopump 10 such that a gas whose vapor pressure is sufficiently low at the cooling temperature (e.g., water vapor or the like) will be condensed and pumped on the surface of the baffle 62. A gas whose vapor pressure is not sufficiently low at the cooling temperature of the baffle 62 enters into the radiation shield 40 through the baffle 62. Of the entered gas molecules, a gas whose vapor pressure is sufficiently low at the cooling temperature of the cryopanel 60 will be condensed and pumped on the surface of the cryopanel 60. A gas whose vapor pressure is not sufficiently low at the cooling temperature (e.g., hydrogen or the like) is adsorbed and pumped by an adsorbent, which is adhered to the surface of the cryopanel 60 and cooled. In this way, the cryopump 10 can attain a desired degree of vacuum in the vacuum chamber in which the cryopump 10 has been mounted.

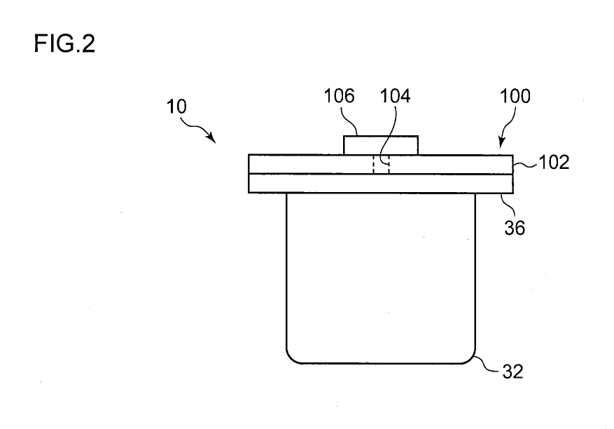

FIG. 2 is a view schematically illustrating a pump cover 100 for the cryopump 10 according to an embodiment of the invention. FIG. 2 illustrates a state where the pump cover 100 is mounted onto the cryopump 10. The pump cover 100 is mounted to the mounting flange 36 and provided as a cover structure for gas-tightly closing the inside of the cryopump 10 with respect to the outside. Accordingly, by closing the pump inlet 34 with the pump cover 100, the inside of the cryopump 10 can be maintained at a negative pressure or vacuum with respect to an external normal pressure.

The pump cover 100 comprises a cover main body 102 configured to close the pump inlet 34. The cover main body 102 is, for example, a plate-shaped member having a shape corresponding to the shape of the pump inlet 34. In an embodiment, the pump inlet 34 has a circular shape and the mounting flange 36 is annularly provided to be located along the outer circumference of the pump inlet 34. In this case, the cover main body 102 is a circular plate member having a larger diameter than that of the pump inlet 34, for example, the same diameter as the outer diameter of the mounting flange 36. The cover main body 102 is formed of, for example, a metal. The cover main body 102 is mounted to the mounting flange 36 by an appropriate mounting method, for example, by using a bolt and nut. For example, the cover main body 102 is fixed to the mounting flange 36 at equal intervals by using a plurality of bolts and nuts. Hereinafter, for convenience, a surface of the cover main body 102, oriented toward the inside of the cryopump 10, is referred to as the “lower surface”, while a surface thereof, oriented toward the outside thereof, is referred to as the “upper surface”. The same is true for a closing member 106, which is later-described.

The cover main body 102 has a small hole 104 for communicating the inside of the cryopump 10 to the outside. The small hole 104 is an opening for connecting the upper surface of the cover main body 102 to the lower surface thereof. The small hole 104 is, for example, a circular opening, but may have any opening shape. The size of the small hole 104 is smaller than that of the pump inlet 34, and specifically, it is designed in view of a pressure that acts on the closing member 106. It is preferable that the diameter or width of the small hole 104 is, for example, within a range of 1 mm to 10 mm. The small hole 104 is formed at the center of the cover main body 102, but should not be limited thereto and may be formed at any position in the cover main body 102 in order to communicate the inside of the cryopump 10 to the outside. In order to illustrate the side view of the cryopump 10 in FIG. 2, the small hole 104 is indicated by dotted lines at a portion in the cover main body 102, corresponding to the position where the small hole is formed.

A sealing member for ensuring gas-tightness, for example, an O-ring may be provided in an annular portion on the lower surface of the cover main body 102, the annular portion being located along the mounting flange 36. Alternatively, an annular elastic member (e.g., a rubber member) may be interposed between the lower surface of the cover main body 102 and the mounting flange 36. In this case, the cover main body 102 may be mounted to the mounting flange 36 by using a bolt penetrating all of the cover main body 102, the elastic member, and the mounting flange 36. By interposing an elastic member having an adjusted height, the gap between the lower surface of the cover main body 102 and the baffle 62 (see FIG. 1) can be appropriately maintained. In particular, when the upper end of the baffle 62 protrudes more upward than the mounting flange 36, a concave portion may be provided on the lower surface of the cover main body 102 so as to house the upper end of the baffle 62; however, it is easier and more preferable to interpose the aforementioned elastic member.

The pump cover 100 further comprises the closing member 106 configured to close the small hole 104. The closing member 106 is, for example, a plate-shaped member having a shape corresponding to the shape of the small hole 104. In an embodiment, the small hole 104 has a circular shape and the closing member 106 has a small circular lid having a diameter larger than that of the small hole 104. The closing member 106 is a cover member smaller than the cover main body 102. The closing member 106 is formed of, for example, a metal.

The closing member 106 is mounted to the outside of the cover main body 102. That is, the closing member 106 is mounted to the cover main body 102 such that the lower surface of the closing member 106 is engaged with the upper surface of the cover main body 102. The closing member 106 is mounted to the annular portion of the cover main body 102 that defines the small hole 104, by an appropriate mounting method, for example, by using a bolt or screw. A sealing member for ensuring the gas-tightness with the cover main body 102, for example, an O-ring may be provided along the annular portion on the lower surface of the closing member 106. Thus, the closing member 106 is configured to be in a manner removable outside the cryopump 10.

In another embodiment, the closing members 106 may be a substrate having an adhesive layer on its surface, for example, such as a seal, sticker, or tape. The pump cover 100 may have a structure in which the small hole 104 is closed by pasting such a seal to the small hole 104. In this case, it is desirable to make the small hole 104 smaller than that of the aforementioned small cover closing structure in view of the durability with respect to a differential pressure between the upper and lower surfaces of the seal (i.e., between the inside and outside of the cryopump).

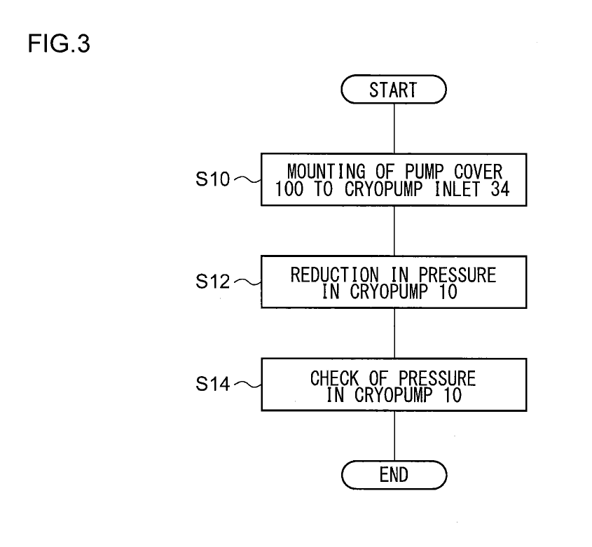

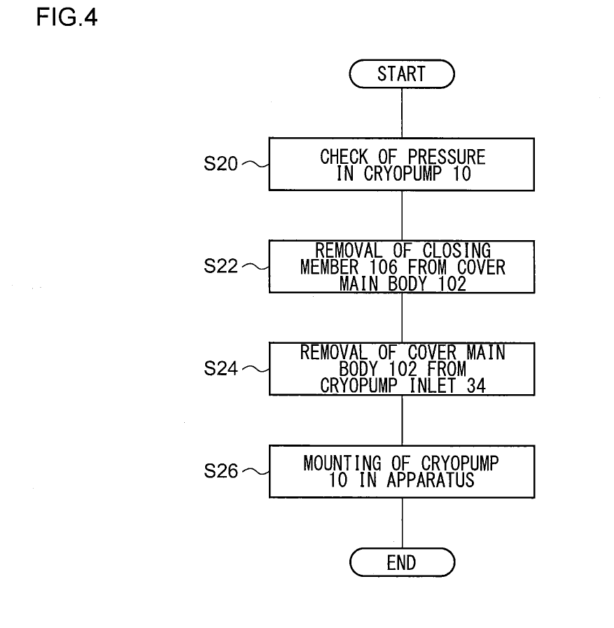

Subsequently, a method of using the pump cover 100 for the cryopump 10 will be described with reference to FIGS. 3 and 4. FIG. 3 is a flowchart for explaining a storage method of the cryopump 10 according to an embodiment of the present invention. FIG. 4 is a flowchart for explaining a start-up method of the cryopump 10 according to an embodiment of the invention.

The method illustrated in FIG. 3 may be performed by a worker when the cryopump 10 is to be stored. For example, it may be performed for shipping and transportation to a user in the final stage of the manufacturing process of the cryopump 10. A storage method of a cryopump will be provided in which the inside of the cryopump 10 is maintained at a negative pressure or vacuum in shipping the cryopump 10 and the negative pressure or vacuum is maintained throughout the shipping to a user and a storage period.

The worker first closes, with a cover, the cryopump inlet 34 for receiving gases to be pumped by the cryopump (S10). In an embodiment, this cover is the aforementioned pump cover 100. The cover main body 102 of the pump cover 100 is mounted to the mounting flange 36 in the cryopump 10 by an appropriate mounting method, for example, by using a bolt and nut. The small hole 104 of the pump cover 100 has been closed in advance by the closing member 106. Accordingly, the inside of the cryopump 10 is in an gastight state by installing the pump cover 100 onto the cryopump 10.

Subsequently, the worker reduces a pressure in the cryopump 10 through a fluid channel for communicating the inside of the cryopump 10 to the outside (S12). In an embodiment, because the pump inlet 34 has been already closed by the pump cover 100, this fluid channel is different from the channel passing through the pump inlet 34. In an embodiment, a pressure in the cryopump 10 is reduced through any one of valves connecting the inside and outside of the cryopump 10.

In a preferred embodiment, the inside of the cryopump 10 is vacuumed through the rough valve 72 by using the roughing pump 73. The pressure in the cryopump 10 is reduced to an appropriate setting pressure or less, for example, to 0.1 atm or less. This pressure can be appropriately determined by experiments or from an empirical standpoint such that, for example, when the adsorbent that is built in the cryopump 10 is stored under the pressure for a long time, an adsorbed amount of a gas (in particular, moisture) is within an acceptable range. In an embodiment, an operating time during which the roughing pump 73 for the vacuuming is operating can be appropriately determined by experiments, etc., so as to be enough for the pressure in the cryopump 10 to be made lower than or equal to a setting pressure.

In an embodiment, the internal pressure of the cryopump 10 may be checked after the vacuuming (S14). For example, it may be confirmed by operating the pressure sensor 54 (e.g., a crystal gauge) whether a negative pressure in the cryopump 10 is lower than or equal to the aforementioned setting pressure. When it has been confirmed that the internal negative pressure is lower than or equal to the setting pressure, a worker ends the process. When the internal negative pressure is not reduced to the setting pressure, vacuuming may be performed again. Because the internal negative pressure normally reaches the setting pressure after the vacuuming for the aforementioned operating time, this checking step may be omitted.

In an embodiment, the checking step of the internal negative pressure, in which the pressure sensor 54 is operated, may be performed as needed during the storage of the cryopump 10. When the pressure in the cryopump 10 measured by the pressure sensor 54 is lower than or equal to the setting pressure, it is ensured that the adsorbent built in the cryopump 10 is maintained in an initial storage state continuously until the moment. Thus, a method of checking a storage state of the cryopump 10 based on an output of the pressure sensor 54 is provided. It can be easily confirmed whether the cryopump 10 has been stored in a good condition.

According to the storage method of the cryopump 10 of an embodiment of the present invention, it can be prevented, by maintaining the inside of the cryopump 10 at a negative pressure or vacuum, that unwanted components (e.g., moisture) may enter the inside thereof. Accordingly, it can be prevented that the adsorbent on a cryopanel, for example, charcoal, may excessively adsorb such unwanted components during the storage. Further, it is expected that the cryopump 10 can be stored at a lower cost and in a better condition than in an alternative method in which the inside of the cryopump 10 is sealed from dried air or nitrogen. Also, it is not needed to fear an adverse influence due to excessive adsorption of nitrogen, etc. Furthermore, it can be prevented by storing the cryopump 10 with the pump inlet 34 being covered that foreign substances may enter the inside thereof.

The method illustrated in FIG. 4 is performed by a worker when operation of the cryopump 10 is initiated after the cryopump 10 has been mounted in an apparatus in which the cryopump is to be mounted, such as a vacuum chamber. The pump cover 100 according to an embodiment of the present invention is mounted in the cryopump 10. A start-up method of a cryopump is provided in which a normal vacuum pumping operation of the cryopump 10 is initiated after the cryopump 10 has been newly mounted or after a used cryopump has been replaced with a new cryopump 10. This start-up method may include preparing, as a spare cryopump, the cryopump 10 to which the aforementioned cryopump storage method has been applied. The spare cryopump is operated by replacing the currently used cryopump 10 with the spare cryopump. The removed cryopump 10 will be subjected to maintenance.

In an embodiment, a worker may first check a pressure in the stored cryopump 10 (S20). In the same way as the aforementioned checking step, it may be confirmed by operating, for example, the pressure sensor 54 (e.g., a crystal gauge) whether the negative pressure in the cryopump 10 is lower than or equal to the aforementioned setting pressure. When it is confirmed that the internal negative pressure is lower than or equal to the setting pressure, the worker continues the process. When the internal negative pressure exceeds the setting pressure, the worker once ends the process to prepare another spare cryopump.

Alternatively, the checking step may be omitted such that a worker presumes the storage condition of the spare cryopump from a situation in which open air enters the inside of the cryopump (e.g., sounds occurring due to the flow of open air) when the closing member 106 is removed, which will be performed in the next step. For example, when sounds due to the inflow of open air are not perceived, it can be considered that the pressure in the cryopump returns, during the storage, to the atmospheric pressure for some reasons. Accordingly, the process is once ended in such the case and another spare cryopump is prepared.

A worker removes the closing member 106 of the pump cover 100 from the cover main body 102 (S22). Because the closing member 106 is a cover member or a seal, etc., whose size is considerably small in comparison with that of the cover main body 102, a differential pressure force that acts thereon is small enough for the closing member 106 to be easily removed. Thus, release of the negative pressure or breaking of the vacuum in the cryopump 10 can be easily performed.

Subsequently, a worker removes the cover main body 102 from the mounting flange 36 in the cryopump 10 (S24). The pump inlet 34 in the cryopump 10 is opened. The cryopump 10 is mounted, via the mounting flange 36, onto a vacuum chamber, etc., in which the cryopump 10 is to be mounted (S26). The inside of the cryopump 10 is vacuumed to the degree of vacuum required for the start of operation by using the roughing pump 73. After this preliminary vacuuming, cryopanel cooling for a vacuum pumping operation of the cryopump 10, i.e., a so-called cool down process is initiated. Thus, installation of the cryopump 10 is performed and the start-up method according to the embodiment of the present invention is ended. Continuously, a normal pumping operation of the cryopump 10 will be initiated.

According to the storage method of the cryopump 10 of an embodiment of the present invention, a period of time required for the installation of the cryopump can be shortened. Mainly, a period of time, during which the pressure in the cryopump is reduced by an auxiliary pump (e.g., roughing pump 73) until it reaches the degree of vacuum required for the start of the cool down, can be drastically shortened. It can be considered that the adsorbent on a cryopanel is in a condition as fresh as in the initial stage of storage such that gases are not substantially released during the vacuuming, and hence it can be predicted that a roughing time can be shortened by, for example, 1 to 2 hours in comparison with the case where the storage state has not been good.

When the inside of the cryopump 10 is vacuum, it is not necessarily easy to remove the cover main body 102 from the pump inlet 34 because the atmospheric pressure externally acts thereon as the force pressing the cover. In the case where the closing member 106 is not provided, the vacuum is broken through any one of valves, instead of directly removing the cover from the pump inlet 34. Because these valves are vacuum valves each having a configuration in which the high vacuum inside the cryopump 10 is surely maintained during a vacuum pumping operation thereof, it is also not necessarily easy to simply open the valve in such the case. Accordingly, the vacuum is broken by removing any one of the valves. The work of removing a valve becomes a burden to a worker and there is also a fear that a vacuum maintaining function may be decreased by erroneously catching foreign substances into a valve in mounting the valve again.

According to an embodiment of the present invention, such a problem can be solved by installing the closing member 106 into a cover structure, the closing member 106 being able to break the vacuum with a force smaller than that required for directly removing the cover main body 102. The storage of the cryopump 10 can be practically and easily adopted in which the cryopump 10 is maintained in a vacuum.

The present invention has been described above based on the embodiments. It should be appreciated by those skilled in the art that the invention is not limited to the above embodiments but various design changes and variations can be made, and such variations are also encompassed by the present invention.

The closing member 106, if it is a small cover member, is preferable in terms of being capable of being reused, but the present invention is not limited thereto. For example, the closing member 106 may be a closing portion that is fixed to or formed integrally with the cover main body 102. The closing portion is formed, for example, to be considerably thinner than the surrounding portion. A worker may break the vacuum by opening a hole in the closing portion with an appropriate tool.

When the closing member 106 is a substrate having an adhesive layer on its surface, the small hole 104 may be closed by pasting it to the inside (i.e., lower surface) of the cover main body 102. In this case, a worker may break the vacuum by breaking the closing member 106 with an appropriate tool being inserted into the small hole 104 from the outside of the cover main body 102. Because the closing member 106 is pasted to the inside, the possibility that the closing member 106 may be erroneously (or intentionally) removed or damaged during the storage can be reduced.

In the aforementioned embodiments, the pressure in the cryopump 10 is reduced for being stored, through a fluid channel for communicating the inside of the cryopump 10 to the outside that is different from the pump inlet 34, but the fluid channel for communicating the inside of the cryopump 10 to the outside may pass through the pump inlet 34. In the case, a worker may reduce the pressure in the cryopump 10 through the pump cover 100.

In an embodiment, the pressure in the cryopump 10 may be reduced through the small hole 104 in the pump cover 100. After the reduction in the pressure, the small hole 104 may be closed by the closing member 106. That is, the pressure in the cryopump 10 is reduced by the installed pump cover 100 whose small hole 104 has been closed, in the aforementioned embodiments; however, in the present variation, the small hole 104 in the pump cover 100 is closed after the pump cover 100 has been installed in the cryopump 10 and the pressure therein has been reduced. In this case, the closing member 106 may be a substrate having an adhesive layer on its surface, for example, such as a seal, sticker, or tape. By closing the small hole 104 promptly, it becomes possible to suppress an increase in the pressure in the cryopump 10, occurring between the completion of the reduction and the closing of the small hole 104, to a sufficiently small level.

It should be understood that the invention is not limited to the above-described embodiment and but may be modified into various forms on the basis of the spirit of the invention. Additionally, the modifications are included in the scope of the invention.

Priority is claimed to Japanese Patent Application No.2011-83629, filed Apr. 5, 2011, the entire content of which is incorporated herein by reference.

What is claimed is:

1. A cover structure for maintaining an inside of a cryopump at a negative pressure, the cover structure comprising:
a cover main body configured to close a pump inlet in the cryopump, the cover main body having a small hole for communicating the inside of the cryopump to an outside of the cryopump; and
a closing member configured to close the small hole.

2. The cover structure according to claim 1, wherein
the closing member includes either a small cover, or a substrate having an adhesive layer on its surface, mounted to an outer side of the cover main body.

3. A cryopump comprising the cover structure according to claim 1.

4. A start-up method of a cryopump comprising releasing a negative pressure in the cryopump by removing the closing member from the cover main body of the cover structure according to claim 1, the cover structure being mounted to the cryopump.

5. A storage method of a cryopump comprising:
closing, with a cover, a pump inlet in the cryopump for receiving gases to be pumped by the cryopump; and
reducing a pressure in the cryopump through a fluid channel for communicating an interior of the cryopump to an exterior of the cryopump.
